(19) United States
(12) Patent Application Publication
(10) Pub. No.: US 2026/0108867 A1
(43) Pub. Date: Apr. 23, 2026

(54) CATALYST FOR REMOVING NITROUS OXIDE AND METHOD OF REMOVING NITROUS OXIDE

(71) Applicant: Industrial Technology Research Institute, Hsinchu (TW)

(72) Inventors: Chuan-Lin Chang, Taichung City (TW); Hong-Ping Lin, Taipei City (TW); Jui-Hsiang Cheng, Taichung City (TW); Shou-Nan Li, Nantou County (TW); Ssu-Ting Liu, Taichung City (TW)

(73) Assignee: Industrial Technology Research Institute, Hsinchu (TW)

(21) Appl. No.: 18/959,667

(22) Filed: Nov. 26, 2024

(30) Foreign Application Priority Data
Oct. 22, 2024 (TW) 113140108

(51) Int. Cl. B01J 23/80; A62D 3/30; A62D 101/47; B01J 35/40; B01J 35/61; C01B 21/22

(52) U.S. Cl. CPC B01J 23/80; A62D 3/30; B01J 35/40; B01J 35/613; B01J 35/615; C01B 21/22; A62D 2101/47; B01J 2523/17; B01J 2523/22; B01J 2523/27; B01J 2523/31; B01J 2523/842

(57) ABSTRACT

A catalyst for removing nitrous oxide and a method of removing nitrous oxide are provided. The catalyst includes a metal oxide powder and an iron-copper compound. The iron-copper compound is attached to the surface of the metal oxide powder, where the metal oxide powder includes zinc oxide, magnesium oxide, aluminum oxide, or a combination thereof. A molar ratio of iron in the iron-copper compound to the metal in the metal oxide powder is 1:1.3-4.0.

### CROSS-REFERENCE TO RELATED APPLICATION

This application claims the priority benefit of Taiwan application serial no. 113140108, filed on Oct. 22, 2024. The entirety of the above-mentioned patent application is hereby incorporated by reference herein and made a part of this specification.

### TECHNICAL FIELD

The disclosure relates to a catalyst for removing nitrous oxide and a method of removing nitrous oxide.

### BACKGROUND

A study of N₂O decomposition catalysts has been conducted for many years. In addition to being used for treating industrial waste gases (for example, exhaust gases containing N₂O in semiconductor process), N₂O decomposition catalysts are also widely applied in automobile exhaust pipes. The active agent in these catalysts is mostly precious metals, which leads to high costs and difficulties in mass production, as well as the disadvantage of reduced catalytic activity due to interference from water vapor and oxygen.

Moreover, the conventional treatment technologies only have about 60% treatment efficiency of N₂O. If a high-temperature thermal decomposition method is used instead to treat N₂₀, the method may result in the emission of large amounts of air pollutants NOx.

### SUMMARY

A catalyst for removing nitrous oxide provided by the disclosure includes a metal oxide powder and an iron-copper compound, where the iron-copper compound adheres to the surface of the metal oxide powder. The metal oxide powder may include zinc oxide, magnesium oxide, aluminum oxide, or a combination thereof. A molar ratio of iron in the iron-copper compound to a metal in the metal oxide powder is 1:1.3 to 4.0.

A method of removing nitrous oxide of the disclosure uses the aforementioned catalyst to decompose nitrous oxide into nitrogen (N₂) and oxygen (O₂).

To make the aforementioned features of the disclosure comprehensible, embodiments are provided below with detailed explanations in conjunction with the accompanying drawings.

### BRIEF DESCRIPTION OF THE DRAWINGS

FIG. 1 is an X-ray diffraction analysis (XRD) spectrum of catalysts of Example 12, Comparative Example 3, and Example 1.

FIG. 2 is an XRD spectrum of catalysts of Example 16 and Example 1.

FIG. 3 is a schematic diagram of an instrument used in experimental examples to detect gas concentration and destruction and remove efficiency (DRE).

FIG. 4 is a curve diagram showing the N₂O DRE and NO₂ concentration of Example 7.

FIG. 5 is a curve diagram showing the N₂O DRE and NO₂ concentration of Example 12.

FIG. 6 is a catalyst lifespan curve diagram of Example 7.

### DETAILED DESCRIPTION OF DISCLOSED EMBODIMENTS

The following content provides many different embodiments to implement various features of the disclosure. However, these embodiments are for demonstration purposes only and are not intended to limit the scope and application of the disclosure.

In an embodiment of the disclosure, a catalyst for removing nitrous oxide includes a metal oxide powder and an iron-copper compound. The aforementioned metal oxide powder may include zinc oxide, magnesium oxide, aluminum oxide, or a combination thereof. In the aforementioned iron-copper compound, iron and copper may exist in the form of iron oxide, copper oxide, or a combination thereof, respectively. The aforementioned iron-copper compound may be a binary iron-copper (Fe—Cu) compound. The aforementioned iron-copper compound may be composed of copper oxide and iron oxide. The aforementioned iron-copper compound may also be doped with other elements to improve the characteristics of the catalyst. For example, the iron-copper compound doped with an aluminum compound may also be called an aluminum-doped iron-copper compound, which is mainly composed of copper oxide and iron oxide and contains a small amount of aluminum oxide to improve the mechanical properties of the catalyst. The molar ratio of iron in the aforementioned iron-copper compound to the metal in the metal oxide powder may be 1:1.3 to 4.0. For example, when the metal oxide powder is zinc oxide, the molar ratio of iron in the iron-copper compound to zinc in the zinc oxide powder is 1:1.4 to 4.0; when the metal oxide powder is magnesium oxide, the molar ratio of iron in the iron-copper compound to magnesium in the magnesium oxide powder is 1:1.4 to 4.0; when the metal oxide powder is aluminum oxide, the molar ratio of iron in the iron-copper compound to aluminum in an aluminum oxide powder is 1:1.3 to 3.6.

In an embodiment, when the metal oxide powder is zinc oxide, the molar ratio of iron to copper in the iron-copper compound is 1:1.8 to 6.2. In some embodiments, when the metal oxide powder is magnesium oxide, the molar ratio of iron to copper in the iron-copper compound is 1:1.5 to 6.0. In some embodiments, when the metal oxide powder is aluminum oxide, the molar ratio of iron to copper in the iron-copper compound is 1:0.2 to 2.7. When the molar ratio of iron to copper is within the above ranges, an excellent nitrous oxide destruction and removal efficiency (DRE) may be obtained.

In addition, by X-ray diffraction analysis (XRD), it is discovered that when the metal oxide powder is zinc oxide or magnesium oxide, the formed catalyst exhibits distinct Fe₃O₄ diffraction peaks. Therefore, it may be inferred that the catalyst also includes an Fe₃O₄ crystal structure.

In an embodiment, the catalyst for removing nitrous oxide may also contain a small amount of aluminum, for instance, the molar ratio of iron in the iron-copper compound to the aforementioned small amount of aluminum may be 1:0.1 to 0.5, and the aluminum may exist in the form of aluminum oxide on the surface of the metal oxide powder.

In an embodiment, the specific surface area of the catalyst for removing nitrous oxide is 20 m² g⁻¹ to 200 m²g⁻¹.

In an embodiment, the particle size of the catalyst for removing nitrous oxide may be greater than or equal to 100 μm, for instance, approximately 200 μm to 5 mm, or for example, approximately 1 mm to 5 mm.

In an embodiment, the porosity of the catalyst for removing nitrous oxide may be 60% to 90%.

In an embodiment, when the particle size of the catalyst is relatively large (for instance, greater than or equal to 1 mm), the mechanical intensity of the catalyst for removing nitrous oxide may be 0.5 kgw to 3.0 kgw, which helps to avoid fragmentation during use that may affect the nitrous oxide treatment process.

In an embodiment, the catalyst for removing nitrous oxide may be obtained by granulation and calcination processes, causing the iron-copper compound to adhere to the surface of the metal oxide powder.

In another embodiment of the disclosure, a method of removing nitrous oxide involves using the aforementioned catalyst to decompose nitrous oxide into nitrogen (N₂) and oxygen (O₂). Moreover, when the flow rate of nitrous oxide is between 400 sccm to 1350 sccm, a 99% nitrous oxide DRE may be achieved, without generating harmful by-products such as NOx.

The catalyst for removing nitrous oxide of the disclosure may be used to treat exhaust gas containing N₂O in semiconductor process, waste gas generated from nitric acid and adipic acid production (for example, 2HNO₃→N₂O+H₂O+O₂), medical anesthetic waste gas, and even waste gas containing flammable gases such as CH₄ and H₂.

The nitrous oxide decomposition catalyst of the disclosure achieves a considerably high nitrous oxide DRE by combining low-cost transition metals with metal oxide carriers. For example, the nitrous oxide decomposition catalyst may replace the high-temperature thermal decomposition method commonly used for treating N₂O exhaust gas in semiconductor processes, completely decomposing N₂O into N₂ and O₂, and achieving zero pollution emission.

The following examples illustrate several experiments to verify the efficacy of the disclosure, but these experiments and their results are not intended to limit the scope of application of the disclosure.

### Preparation Example 1 Catalyst Containing Zinc Oxide Powder and Iron-Copper Compound

According to the usage amounts in Table 1 below, the following preparations were conducted to obtain Examples 1 to 4.

First, a zinc oxide powder (Taimau, Model AZO-900) was dispersed in water, called a colloidal solution 1. Iron nitrate was dissolved in water to form a solution 2. The solution 2 and a 2.0 M sodium hydroxide solution (pH adjuster) were added to the colloidal solution 1, then reacted at room temperature (about 25° C.) for 1.5 hours to form a colloidal solution 3.

After precipitation, the colloidal solution 3 was filtered and dried to obtain the precipitate. After the aforementioned precipitate was dispersed in water, 4 wt % biopolymer solution as a chelating agent was added into the dispersion and mixed to form a uniform colloidal solution 4, where the biopolymers may include but are not limited to alginic acid, cellulose, chitin, chitosan, carrageenan, gelatin, etc. Next, the colloidal solution 4 was added to a copper nitrate solution (15,000 ppm of copper ion concentration) to form granules. The aforementioned granules were heat treated at a calcination temperature of 500° C. to obtain Fe/Cu/ZnO catalyst.

TABLE 1

| | Iron | Zinc |
|---|---|---|
| Example | nitrate | oxide powder |
| 1 | 83.8 grams | 16.89 grams |
| 2 | 83.8 grams | 33.78 grams |
| 3 | 83.8 grams | 50.67 grams |
| 4 | 83.8 grams | 67.56 grams |

### Preparation Example 2 Catalyst Containing Zinc Oxide Powder and Iron-Copper Compound

Examples 5 to 8 were prepared according to the following method.

As in Preparation Example 1, 33.78 grams of the zinc oxide powder were first dispersed in water, called a colloidal solution 1. 83.8 grams of iron nitrate were dissolved in water to form a solution 2. Additionally, the solution 2 was added to the colloidal solution 1, then stirred at room temperature for 1 hour, called a colloidal solution 3. Next, 2.0 M potassium carbonate (pH adjuster) was added to the colloidal solution 3, and stirred again at room temperature for 1 hour, called a colloidal solution 4.

After precipitation, the colloidal solution 4 was filtered and dried to obtain the precipitate. After the aforementioned precipitate was dispersed in water, 4 wt % biopolymer solution as a chelating agent was added into the dispersion and mixed to form a uniform colloidal solution 5. Next, the colloidal solution 5 was added to the copper nitrate solution (15,000 ppm of copper ion concentration) and left to stand (for 3, 8, 24, and 24 hours for Examples 5 to 8 respectively) to form granules. Finally, the aforementioned granules were heat treated (calcination temperature was about 500° C. for Examples 5 to 7, and about 400° C. for Example 8) to obtain Fe/Cu/ZnO catalyst.

### Preparation Example 3 Catalyst Containing Zinc Oxide Powder and Iron-Copper Compound

The preparation was conducted by using the same method as Example 8 in Preparation Example 2 and according to the usage amounts in Table 2 below. Only Example 9 had a calcination temperature of 300° C., while the remaining examples had a calcination temperature of 500° C., to obtain Examples 9 to 11.

TABLE 2

| | Iron | Zinc | |
|---|---|---|---|
| Example | nitrate | oxide powder | |
| 9 | 83.8 grams | 33.78 | grams |
| 10 | 83.8 grams | 8.45 | grams |
| 11 | 83.8 grams | 84.45 | grams |

### Comparative Preparation Example 1 Catalyst Containing Zinc Oxide Powder and Iron or Copper Compound

The catalyst was prepared using the same method as Example 7 in Preparation Example 2, but instead of using the copper nitrate solution, 15000 ppm of a zinc nitrate solution was used, to obtain Comparative Example 1.

The catalyst was prepared by using the same method as Example 7 in Preparation Example 2, but 83.7 grams of copper nitrate was used instead of iron nitrate, to obtain Comparative Example 2.

### Comparative Preparation Example 2 Catalyst Containing Titanium Oxide Powder and Iron-Copper Compound

The catalyst was prepared by using the same method as Example 1 in Preparation Example 1, but instead of the zinc oxide powder, 33.2 grams of titanium oxide (Di Yi Chemical, Product Number 20130227123, average particle size 30 nm) was used, to obtain Comparative Example 3.

### Preparation Example 4 Catalyst Containing Aluminum Oxide Powder and Iron-Copper Compound

According to the usage amounts in Table 3 below, the following preparations were conducted to obtain Examples 12 to 15.

First, the aluminum oxide powder was dispersed in water, called a colloidal solution 1, where aluminum oxide was purchased from EIKME, Material Number A000WL, and monohydrate aluminum oxide was purchased from Zibo Honghe Chemical Co., Ltd, Material Number AC-G2. 80.9 grams of iron nitrate and 12.1 grams of copper nitrate were dissolved in water to form a solution 2. The solution 2 and 2.0 M sodium hydroxide solution were added to the colloidal solution 1, then reacted at room temperature for 1.5 hours to form a colloidal solution 3.

After precipitation, the colloidal solution 3 was filtered and dried to obtain the precipitate. After the aforementioned precipitate was dispersed in water, 4 wt % biopolymer solution as a chelating agent was added into the dispersion and mixed to form a uniform colloidal solution 4. Next, the colloidal solution 4 was added to the copper nitrate solution (15,000 ppm of copper ion concentration) to form granules. The aforementioned granules were heat treated at a calcination temperature of 500° C. to obtain the Fe/Cu/Al₂O₃ catalyst.

TABLE 3

| | Aluminum | Usage amount of |
|---|---|---|
| Example | oxide powder | aluminum oxide powder |
| 12 | Aluminum oxide | 20.4 grams |
| 13 | Boehmite | 24.0 grams |
| 14 | Aluminum oxide | 20.4 grams |
| 15 | Aluminum oxide | 30.6 grams |

### Comparative Preparation Example 3 Catalyst Containing Aluminum Oxide Powder but No Copper Compound

According to the usage amounts in Table 4 below, the following preparations were conducted to obtain Comparative Examples 4 to 6.

The catalyst was prepared by using the same method as Example 14 in Preparation Example 4.

TABLE 4

| Comparative | Copper | Substitute for | |
|---|---|---|---|
| example | nitrate | copper nitrate solution | |
| 4 | None | Nickel nitrate | Concentration: 15000 ppm |
| 5 | None | Calcium | Concentration: 15000 ppm |
| | | chloride | |
| 6 | None | Aluminum | Concentration: 15000 ppm |
| | | nitrate | |

### Preparation Example 5 Catalyst Containing Magnesium Oxide Powder and Iron-Copper Compound

First, 40.4 grams of magnesium oxide powder (Kamishima Chemical Co., Ltd., Material Number #50), and 83.8 grams of iron nitrate were dispersed in water, which was called a colloidal solution 1. Next, 2.0 M potassium carbonate was added to the colloidal solution 1, and stirred for another 1 hour at room temperature, which was called a colloidal solution 2. After precipitation, the colloidal solution 2 was filtered and dried to obtain the precipitate.

After the aforementioned precipitate is dispersed in water, a 4 wt % biological polymer solution was added into the dispersion and mixed to form a uniform colloidal solution 3. Next, the colloidal solution 3 was added to the copper nitrate solution (15,000 ppm of copper ion concentration) to form granules. The aforementioned granules were subjected to heat treatment at a calcination temperature of 500° C. to obtain the Fe/Cu/MgO catalyst of Example 16.

[symbol]

Physical Property Analysis

[symbol]

### 1. XRD Analysis

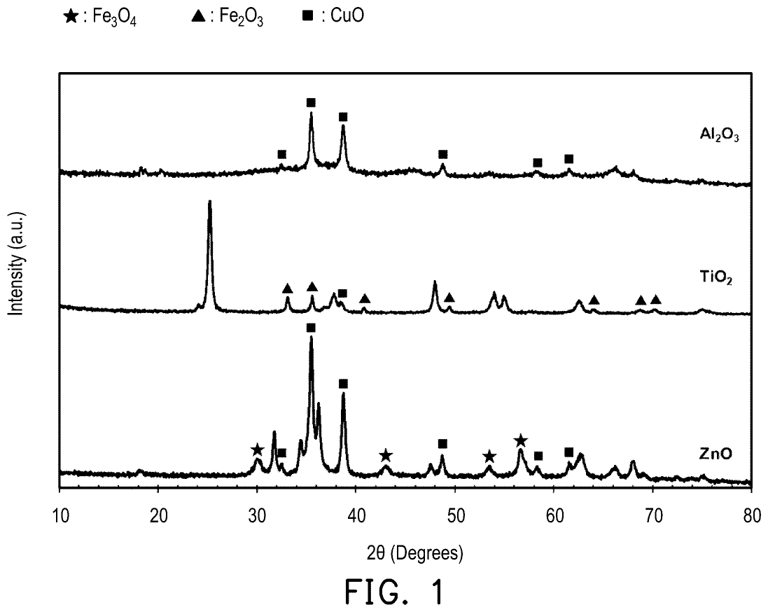

The catalysts of Example 12, Comparative Example 3, and Example 1 were analyzed by an XRD equipment to obtain an XRD diagram shown in FIG. 1. From FIG. 1, it can be seen that the catalyst using the zinc oxide (ZnO) powder as a carrier has obvious Fe₃O₄ diffraction peaks; therefore, it may be inferred that this catalyst has an Fe₃O₄ crystal structure.

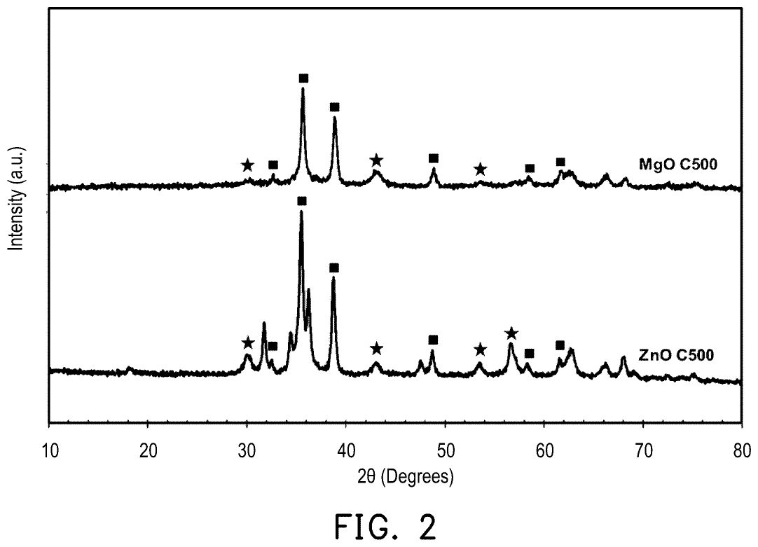

By using the XRD equipment, the XRD analysis results of the catalyst of Example 16 were compared with the XRD diagram of Example 1, as shown in FIG. 2. The catalyst using magnesium oxide (MgO) powder as a carrier also has obvious Fe₃O₄ diffraction peaks (marked with asterisks); therefore, it may be inferred that this catalyst also has an Fe₃O₄ crystal structure.

2. Molar ratio: The content and relative amount of specific elements in the catalyst were obtained by using an energy dispersive X-ray (EDX) instrument (Hitachi S-4800). Additionally, EDX-Mapping was performed by using a scanning electron microscope (Hitachi SU8010) with a fixed operating voltage of 10-15 kV for element detection and localization.

The molar ratios of iron to metal (in the metal oxide powder) for each Example and Comparative Example, measured according to the aforementioned method, are listed in Table 5 to Table 7 below.

The molar ratios of iron to copper in catalysts with different metal oxide powders are as follows.

In the Examples/Comparative Examples where the metal oxide powder is zinc oxide (ZnO), the molar ratio of iron to copper in Example 1 is 1:4.2, in Example 2 is 1:6.0, in Example 3 is 1:4.4, in Example 4 is 1:5.3, in Example 5 is 1:2.0, in Example 6 is 1:3.2, in Example 7 is 1:3.4, in Example 8 is 1:3.4, in Example 9 is 1:3.4, in Example 10 is 1:5.7, in Example 11 is 1:7.2, in Comparative Example 1 is 1:0, and in Comparative Example 2 is 0:1.

In Comparative Example 3 where the metal oxide powder is titanium oxide (TiO₂), the molar ratio of iron to copper is 1:1.3.

In the Examples where the metal oxide powder is aluminum oxide (Al₂O₃), the molar ratio of iron to copper in Example 12 is 1:0.7, in Example 13 is 1:1.3, in Example 14 is 1:0.5, and in Example 15 is 1:2.5.

In Example 16 where the metal oxide powder is magnesium oxide (MgO), the molar ratio of iron to copper is 1:2.8.

3. Specific surface area and porosity: The specific surface area is measured by using a nitrogen gas isothermal adsorption-desorption instrument (Micromeritics TriStar II). The nitrogen gas isothermal adsorption-desorption test is conducted under temperature conditions controlled at 77 K to measure the specific surface area of the material. The porosity is measured by using a graduated cylinder, and is defined as (water weight after filling the catalyst/water weight without filling the catalyst)×100% in a fixed volume.

The specific surface area and porosity of each Example and Comparative Example measured according to the aforementioned method are also listed in the following Table 5 to Table 7.

[symbol]

Evaluation Method

[symbol]

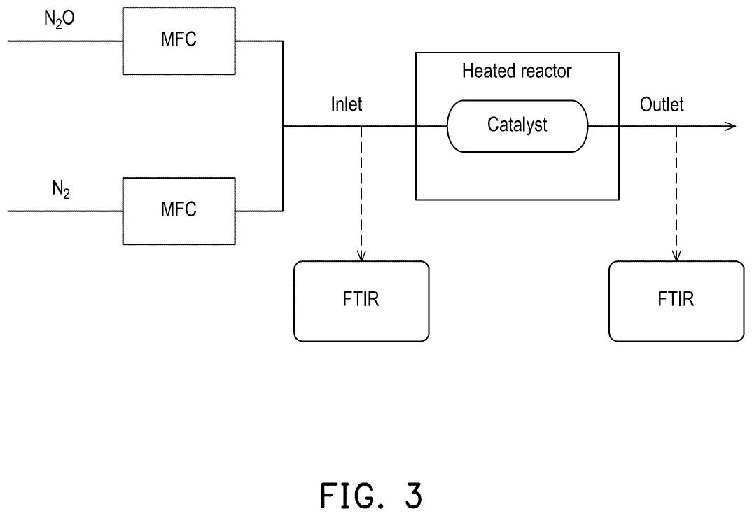

1. DRE and NOx concentration: The detection is conducted by using the instrument shown in FIG. 3, which includes providing a heated reactor. The catalyst of each Example and Comparative Example is placed in the heated reactor, and corresponding FTIR detectors are installed at the inlet and outlet of the heated reactor to detect the concentration and changes (that is, DRE) of specific gas species before and after entering the heated reactor (after being processed by the catalyst). The catalyst volume is 20 mL, and the temperature of the heated reactor is maintained at 500° C. Simultaneously, nitrous oxide (N₂O) and nitrogen (N₂) are input to the inlet by mass flow controllers (MFC), where the volume concentration of nitrous oxide is 1%, and the flow rate is controlled to enter the heated reactor at 400 sccm to 1350 sccm.

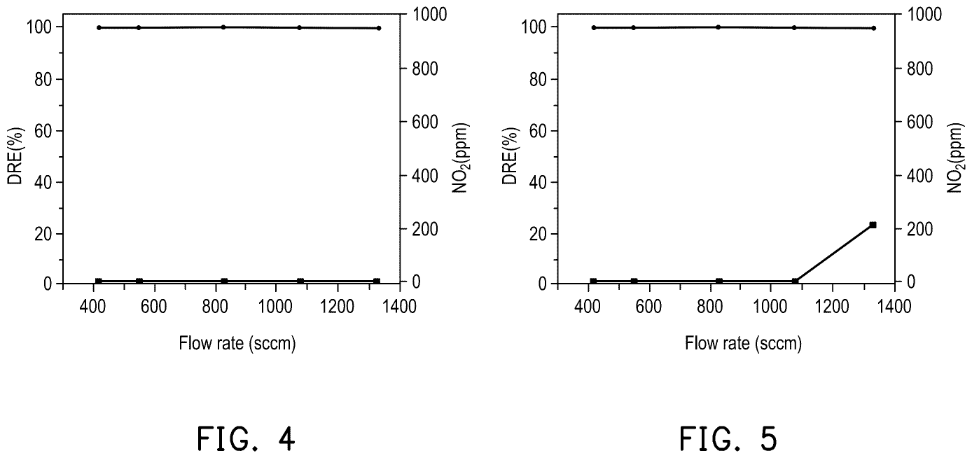

FIG. 4 is a curve diagram showing the N₂O DRE and NO₂ concentration of Example 7. FIG. 5 is a curve diagram showing the N₂O DRE and NO₂ concentration of Example 12. From FIG. 4 and FIG. 5, it can be observed that the catalyst of the disclosure has a DRE as high as 99% or more at 500° C., and almost no NO₂ is produced.

The DRE at 450° C. and 500° C. and the concentration of NOx by-products of each Example and Comparative Example measured according to the aforementioned methods are also listed in the following Table 5 to Table 7.

TABLE 5

| | Molar | Specific | | | | | |
|---|---|---|---|---|---|---|---|
| | ratio of | surface | | DRE at | DRE at | NOx | |
| Example | Iron:metal | area | Porosity | 450° C. | 500° C. | concentration | |
| 1 | 1:1.6 | 21 m² g⁻¹ | 85% | 90% | >99% | <200 | ppm |
| 2 | 1:2.3 | 20 m² g⁻¹ | 84% | 98% | >99% | <200 | ppm |
| 3 | 1:3.4 | 11 m² g⁻¹ | 78% | 83% | >99% | <200 | ppm |
| 4 | 1:3.8 | 15 m² g⁻¹ | 83% | 84% | >99% | <200 | ppm |
| 5 | 1:2.9 | 42 m² g⁻¹ | 81% | 99% | >99% | <200 | ppm |
| 6 | 1:2.3 | 48 m² g⁻¹ | 85% | >99% | >99% | <200 | ppm |
| 7 | 1:2.5 | 30 m² g⁻¹ | 79% | >99% | >99% | <200 | ppm |
| 8 | 1:2.5 | 47 m² g⁻¹ | 84% | 99% | >99% | <200 | ppm |
| 9 | 1:2.5 | 51 m² g⁻¹ | 86% | 97% | >99% | 948 | ppm |
| 10 | 1:1.0 | 25 m² g⁻¹ | 81% | 46% | 84% | <200 | ppm |
| 11 | 1:3.7 | 26 m² g⁻¹ | 83% | 31% | 76% | <200 | ppm |

TABLE 6

| | Molar | Specific | | | | | |
|---|---|---|---|---|---|---|---|
| Comparative | ratio of | surface | | | DRE at | DRE at | NOx |
| example | Iron:metal | area | | Porosity | 450° C. | 500° C. | concentration |
| 1 | 1:3.0 | 45 | m² g⁻¹ | 79% | 50% | 96% | <200 ppm |
| 2 | Iron-free | 34 | m² g⁻¹ | 75% | <5% | <5% | <200 ppm |
| 3 | 1:3.6 | 41 | m² g⁻¹ | 70% | 39% | 87% | <200 ppm |
| 4 | 1:2.5 | 157 | m² g⁻¹ | 91% | <5% | 27% | <200 ppm |
| 5 | 1:1.3 | 130 | m² g⁻¹ | 74% | 9% | 37% | <200 ppm |
| 6 | 1:1.9 | 164 | m² g⁻¹ | 69% | 34% | 93% | <200 ppm |

TABLE 7

| | Molar | Specific | | | | |
|---|---|---|---|---|---|---|
| | ratio of | surface | | DRE at | DRE at | NOx |
| Example | Iron:metal | area | Porosity | 450° C. | 500° C. | concentration |
| 12 | 1:2.3 | 174 m² g⁻¹ | 65% | >99% | >99% | <200 ppm |
| 13 | 1:2.2 | 195 m² g⁻¹ | 67% | 89% | >99% | <200 ppm |
| 14 | 1:1.5 | 149 m² g⁻¹ | 74% | 91% | >99% | <200 ppm |
| 15 | 1:3.4 | 152 m² g⁻¹ | 67% | 67% | >99% | <200 ppm |
| 16 | 1:3.2 | — | — | — | >99% | <200 ppm |

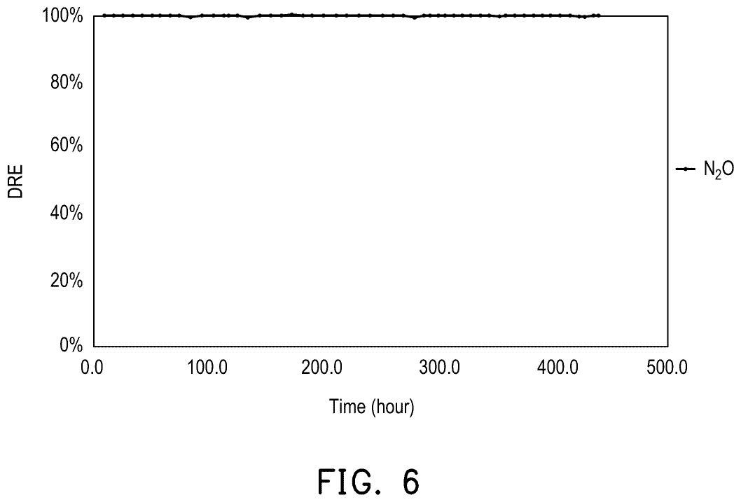

In addition, a catalyst lifespan test for the catalyst of Example 7 is conducted by using the instrument shown in FIG. 3, where the total gas flow rate is 623.3 sccm, the catalyst volume is 20 mL, and the space velocity is 1870 h⁻¹. The results are shown in FIG. 6.

From FIG. 6, it may be obtained that the catalyst of Example 7 may continuously operate for more than 430 hours under the aforementioned conditions, with the nitrous oxide DRE at 500° C. maintained above 99%. Therefore, the catalyst of the disclosure has the effects of high stability and high efficiency.

In addition, if the preparation method of the catalyst of Example 13 is adopted but only the calcination temperature is changed to 800° C., the nitrous oxide DRE is verified to be greater than 99% by the aforementioned tests, but the NOx by-product concentration is about 1000 ppm.

2. Mechanical intensity: By using the TH-1 digital tablet hardness tester from Xiang Tai Precision Machinery, the compressive intensity of the catalyst is measured in kilogram-force (also known as kgw).

The mechanical intensity measured according to the aforementioned methods is as follows.

In an example where the metal oxide powder is zinc oxide (ZnO), the mechanical intensity is approximately between 0.05 kgw and 0.45 kgw.

In an example where the metal oxide powder is aluminum oxide (Al₂O₃), the mechanical intensity is approximately between 0.20 kgw and 1.60 kgw.

In an example where the metal oxide powder is magnesium oxide (MgO), the mechanical intensity is approximately between 0.15 kgw and 0.75 kgw.

In addition, it was experimentally discovered that if a small amount of aluminum is added during the preparation process, for example, by adding a small amount of aluminum nitrate to Solution 2, the mechanical intensity of the resulting catalyst may be improved, which is beneficial for enhancing the catalyst's lifespan, thereby improving the durability of the entire equipment for removing nitrous oxide.

Although the present disclosure has been disclosed by the above embodiments, it is not intended to limit the present disclosure. Any person skilled in the art may make some modifications and refinements without departing from the spirit and scope of the present disclosure. Therefore, the protection scope of the present disclosure should be defined by the appended claims.

What is claimed is:

1. A catalyst for removing nitrous oxide, comprising:
a metal oxide powder, wherein the metal oxide powder comprises zinc oxide, magnesium oxide, aluminum oxide, or a combination thereof; and
an iron-copper compound, adhering to surface of the metal oxide powder, wherein a molar ratio of iron in the iron-copper compound to a metal in the metal oxide powder is 1:1.3 to 4.0.

2. The catalyst for removing nitrous oxide according to claim 1, wherein the metal oxide powder is zinc oxide or magnesium oxide, and the catalyst further comprises an Fe₃O₄ crystal structure.

3. The catalyst for removing nitrous oxide according to claim 1, wherein when the metal oxide powder is zinc oxide, a molar ratio of iron to copper in the iron-copper compound is 1:1.8 to 6.2, and the molar ratio of iron in the iron-copper compound to the metal in the metal oxide powder is 1:1.4 to 4.0.

4. The catalyst for removing nitrous oxide according to claim 3, further comprising aluminum, wherein a molar ratio of iron in the iron-copper compound to aluminum is 1:0.1 to 0.5.

5. The catalyst for removing nitrous oxide according to claim 1, wherein when the metal oxide powder is magnesium oxide, a molar ratio of iron to copper in the iron-copper compound is 1:1.5 to 6.0, and the molar ratio of iron in the iron-copper compound to the metal in the metal oxide powder is 1:1.4 to 4.0.

6. The catalyst for removing nitrous oxide according to claim 1, wherein when the metal oxide powder is aluminum oxide, a molar ratio of iron to copper in the iron-copper compound is 1:0.2 to 2.7, and the molar ratio of iron in the iron-copper compound to the metal in the metal oxide powder is 1:1.3 to 3.6.

7. The catalyst for removing nitrous oxide according to claim 1, wherein a specific surface area of the catalyst is 20 m²g⁻¹ to 200 m²g⁻¹.

8. The catalyst for removing nitrous oxide according to claim 1, wherein a particle size of the catalyst is greater than or equal to 100 μm.

9. The catalyst for removing nitrous oxide according to claim 1, wherein a porosity of the catalyst is 60% to 90%.

10. The catalyst for removing nitrous oxide according to claim 1, wherein a mechanical intensity of the catalyst is 0.5 kgw to 3.0 kgw.

11. A method of removing nitrous oxide, comprising using the catalyst according to claim 1 to decompose nitrous oxide into nitrogen (N₂) and oxygen (O₂).

12. The method of removing nitrous oxide according to claim 11, wherein a flow rate of the nitrous oxide is 400 sccm to 1350 sccm.
